(19) United States
(12) Patent Application Publication
(10) Pub. No.: US 2018/0348776 A1
(43) Pub. Date: Dec. 6, 2018

(54) VEHICLE CONTROL DEVICE

(71) Applicant: DENSO CORPORATION, Kariya-city, Aichi-pref. (JP)

(72) Inventor: Hiroshi INOU, Kariya-city, Aichi-pref. (JP)

(21) Appl. No.: 15/780,427

(22) PCT Filed: Dec. 2, 2016
(86) PCT No.: PCT/JP2016/085971

§ 371 Date: May 31, 2018

(30) Foreign Application Priority Data
Dec. 4, 2015 (JP) 2015-237549

(51) Int. Cl. G05D 1/02; G05D 1/00; G06F 17/30

(52) U.S. Cl. CPC G05D 1/0223; G05D 2201/0213; G06F 17/30241; G05D 1/0088

(57) ABSTRACT

In a vehicle control device, a control unit acquires a passing target point representing a position of a point that an own vehicle aims to pass in the future (S140) and generates a trajectory for passing the passing target point (S150). Then, the control unit calculates and outputs a control amount of the own vehicle for causing the own vehicle to travel according to the trajectory (S170).

### CROSS REFERENCE TO RELATED APPLICATION

The present international application claims the benefits of priority to JP 2015-237549 A filed to the Japan Patent Office on Dec. 4, 2015, the entire contents of which are incorporated herein by reference.

### TECHNICAL FIELD

The present disclosure relates to a vehicle control device for controlling a motion of an own vehicle.

### BACKGROUND ART

A known device among such a vehicle control device controls a motion of an own vehicle so as to reduce a deviation between a position where the own vehicle should be passing and an actual position of the own vehicle at the present time (for example, see PTL 1).

### CITATION LIST

### Patent Literature

[PTL 1] JP 5561385 B

### SUMMARY OF THE INVENTION

When driving on a road with many curves such as a mountain road, a riding comfort is better if one steers gently using the road width fully rather than completely following a road shape. As a result of detailed examination by the inventor, it has been found that the above-described vehicle control device has a problem that since it controls the own vehicle so as to perfectly coincide with changes in the curvature of the road, the riding comfort deteriorates.

In one aspect of the present disclosure, it is desirable to provide a vehicle control device that controls a motion of an own vehicle with improved riding comfort. In a vehicle control device according to an aspect of the present disclosure, a target point acquisition unit acquires a passing target point representing a position of a point the own vehicle aims to pass in the future, and a trajectory generation unit generates a trajectory for the own vehicle to pass the passing target point. A control amount calculation unit calculates and outputs a control amount of the own vehicle for causing the own vehicle to travel according to the trajectory.

According to such a vehicle control device, since it sets the passing target point which the own vehicle is to pass in the future and controls the own vehicle according to the trajectory including the passing target point, it is possible to suppress the frequency of steering correction made before the own vehicle reaches the passing target point from occurring. Thus, the riding comfort can be improved. That is, conventionally, although a positional error and an angular error were corrected frequently, it is possible that a correction can be made using a continuous trajectory and improves the riding comfort according to the vehicle control device of the present disclosure.

The configurations can be combined in any way as far as the combination is possible. A part of the configurations may be omitted from the combination.

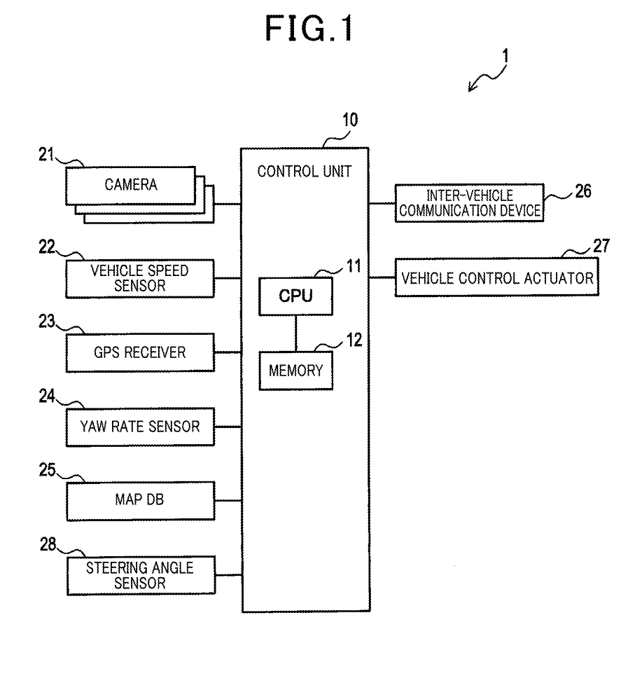

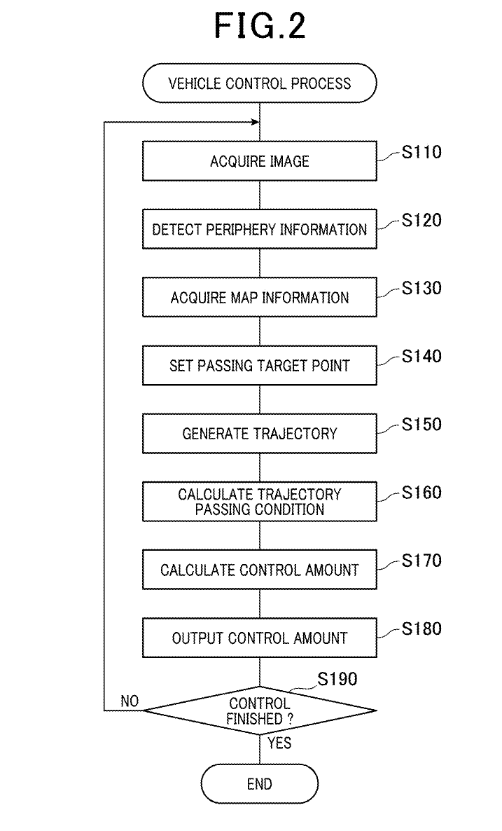

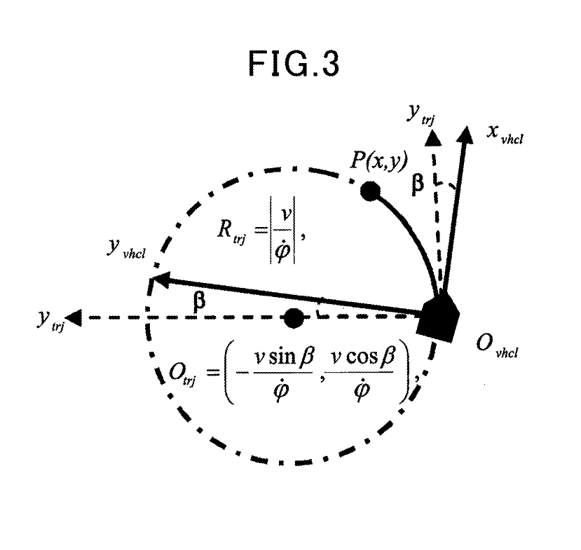

### BRIEF DESCRIPTION OF THE DRAWINGS

[FIG. 1] A block diagram showing a general configuration of a vehicle control device to which the present disclosure has been applied.

[FIG. 2] A flowchart showing a vehicle control process performed by a control unit.

[FIG. 3] A plan view showing an outline of a process for setting a traveling trajectory.

### DESCRIPTION OF THE EMBODIMENTS

An embodiment according to the present disclosure will be described below with reference to the drawings.

### [1-1. Configuration]

A vehicle control device 1 to which the present disclosure is applied is mounted on a vehicle such as a passenger car (hereinafter referred to as an own vehicle). The vehicle control device 1 has a function of controlling motion of the own vehicle, and particularly, it is configured to control the own vehicle to the destination without impairing the riding comfort.

As shown in FIG. 1, the vehicle control device 1 includes a control unit 10, a camera unit 21, a vehicle speed sensor 22, a GPS (Global Positioning System) receiver 23, a yaw rate sensor 24, a map database (DB) 25, an inter-vehicle communication device 26, a vehicle control actuator 27, and a steering angle sensor 28.

The camera unit 21 is configured as a well-known camera system that captures images of the surroundings of the own vehicle using a plurality of cameras. The camera unit 21 sends the captured images obtained from the cameras to the control unit 10. The camera unit 21 is used to recognize positions and speed of other vehicles around the own vehicle by way of image processing.

The vehicle speed sensor 22 is configured as a well-known vehicle speed sensor for detecting the traveling speed of the own vehicle. The vehicle speed sensor 22 sends the detected vehicle speed to the control unit 10. The GPS receiver 23 is configured as a well-known GPS receiver that recognizes the position of the own vehicle by receiving radio waves transmitted from a plurality of GPS satellites.

The GPS receiver 23 sends information on the latitude and longitude of the own vehicle to the control unit 10.

The yaw rate sensor 24 is configured as a well-known yaw rate sensor for detecting the turn angular speed of the own vehicle. The yaw rate sensor 24 sends the detected yaw rate to the control unit 10.

The inter-vehicle communication device 26 performs communication for exchanging position information with other vehicles positioned within the communicable range. In other words, the inter-vehicle communication device 26 transmits position information of the own vehicle to other vehicles and receives information including information for identifying the other vehicles (identification information such as ID) and the other vehicles' position information from the other vehicles. The inter-vehicle communication device 26 sends the obtained information to the control unit 10.

The map DB 25 is configured as a well-known database that stores map information associated with latitudes and longitudes. In the map DB 25, map data in which latitudes and longitudes are associated, such as those used in general navigation systems is stored. From the map DB 25, in response to a request from the control unit 10, map information indicating the surroundings of the own vehicle is mainly read out.

The vehicle control actuator 27 represents an actuator that is required when performing automatic driving of the own vehicle. For example, the vehicle control actuator 27 includes an actuator for controlling an accelerator opening angle and a brake hydraulic pressure of the own vehicle, an actuator for controlling a steering state, and the like.

The steering angle sensor 28 detects a steering angle of the own vehicle and sends the obtained information to the control unit 10.

The control unit 10 is configured as a computer including a CPU 11 and a memory 12 such as ROM and RAM. The CPU 11 performs various processes such as a merging support process described later based on the programs stored in the memory 12.

The various processes include a process of automatically driving the own vehicle. When the own vehicle is to be automatically driven, the map information to the destination is obtained from the map DB 25 and a route to the destination is set. Then, based on the images captured by the camera unit 21 and the map information, a control pattern conforming to the actual road situation is generated, and instructions are sent to the vehicle control actuator 27 according to this control pattern, so that the own vehicle can reach the destination.

A control amount is a parameter related to motion required to control the motion of the own vehicle. For example, the control amounts may include speed, acceleration, turning angle speed, actuation amount of the actuator for changing these, and the like.

### [1-2. Process]

In the vehicle control device 1 configured as described above, the control unit 10 performs the vehicle control process shown in FIG. 2. The vehicle control process starts, for example, when the own vehicle is put in an automatic driving mode and ends when the own vehicle is switched to the manual driving mode.

In the vehicle control process, as shown in FIG. 2, first, images captured by the camera unit 21 are acquired (S110). Then, periphery information is detected (S120). The periphery information indicates information on the positions and speeds of other vehicles positioned around the own vehicle. The periphery information is obtained on the basis of the captured images, inter-vehicle communication, and the detection results of other various sensors.

Next, the map information is acquired (S130). The map information is obtained by reading out the map data of the surroundings of the own vehicle from the map BD 25. The map information includes road state information for each of the number of points on the road through which the own vehicle passes such as a curvature, gradient, lane width, speed limit, etc.

Next, a passing target point is set (S140). The passing target point is set between the current position of the own vehicle and the destination, and within a section from the current position in which at least the curvature of the road is constant.

For example, when the own vehicle is to travel on a road that has a constant curvature for 100 m from the current point, the passing target point is set at an arbitrary point within the section from the current position to 100 m ahead. The curvature of the road needs not be perfectly constant, and the curvature may be assumed to be constant if the change in curvature is such that it is possible to pass without changing the steering angle if the lane width is fully used.

Next, a trajectory to the passing target point is generated (S150). Here, as shown in FIG. 3, the current position of the own vehicle is denoted as Ovhcl, and the passing target point is denoted as P (x, y). The trajectory to the passing target point is an arc trajectory in this example.

More specifically, the relationship of the yaw rate γ, slip angle β, and speed v of the own vehicle can be expressed by the following Eq. [1].

$$\begin{matrix}[ Eq . 1 ] & \\ \frac{d}{dt} [ \begin{matrix}x \\ y \\ ϕ\end{matrix} ] = [ \begin{matrix}cos ϕ & 0 \\ sin ϕ & 0 \\ 0 & 1\end{matrix} ] [ \begin{matrix}v \\ γ + \dot{β}\end{matrix} ] & [ 1 ]\end{matrix}$$

Note that φ represents the azimuth angle based on the absolute coordinate system. The trajectory equation representing the future trajectory of the own vehicle is as follows.

$$\begin{matrix}[ Eq . 2 ] & \\ {( x + \frac{v sin β}{\dot{ϕ}} )}^{2} + {( y - \frac{v cos β}{\dot{ϕ}} )}^{2} = \frac{{\dot{x}}^{2} + {\dot{y}}^{2}}{{\dot{ϕ}}^{2}} & [ 2 ]\end{matrix}$$

This Eq. [2] can be transformed as follows.

$$\begin{matrix}[ Eq . 3 ] & \\ - \frac{( γ + \dot{β} )}{2} + \frac{v}{{x}^{2} + {y}^{2}} ( - x sin β + y cos β ) = 0 & [ 3 ]\end{matrix}$$

If the relational equation represented by Eq. [3] is satisfied, the own vehicle can be controlled so as to pass the passing target point P (x, y).

Next, the trajectory passing condition is calculated (S160). The trajectory passing condition is the motion requirement of the own vehicle to pass through the passing target point P (x, y). From the above Eq. [3], the control objective function can be set as follows.

$$\begin{matrix}[ Eq . 4 ] & \\ u = - \frac{( γ + \dot{β} )}{2} + \frac{v}{{x}^{2} + {y}^{2}} ( - x sin β + y cos β ) & [ 4 ]\end{matrix}$$

The own vehicle can be controlled to pass the passing target point P (x, y) by making u to 0 in this Eq. [4]. That is, the yaw rate γ, slip angle β, and velocity v of the own vehicle should be set so that u=0 is satisfied by any method.

Next, the control amount is calculated (S170). Here, the control amount is obtained by utilizing the motion characteristics of the vehicle. The motion characteristics of a vehicle indicate features and properties that depend on the physical motion of the vehicle, such as mechanical characteristics and vibration characteristics of the vehicle.

First, in this example, the Lyapunov function candidate is used, and it is designed so that the first derivative of the Lyapunov function candidate becomes indefinite.

$$\begin{matrix}[ Eq . 5 ] & \\ V = \frac{2}{1} {u}^{2} \frac{dV}{dt} = - {Ku}^{2} ≦ 0 ( K > 0 ) & [ 5 ]\end{matrix}$$

At this time, the motion equation based on the motion characteristics of the vehicle is considered.

$$\begin{matrix}[ Eq . 6 ] & \\ \frac{d}{dt} [ \begin{matrix}γ \\ β\end{matrix} ] = [ \begin{matrix}{a}_{11} & {a}_{12} \\ {a}_{21} & {a}_{22}\end{matrix} ] [ \begin{matrix}γ \\ β\end{matrix} ] + [ \begin{matrix}{b}_{1} \\ {b}_{2}\end{matrix} ] δ & [ 6 ]\end{matrix}$$

Here, taking various factors such as the ease of implementation, the reliability of sensor values, and the fact that it will be mainly applied to passenger cars into consideration, β and the first derivative of β are assumed be 0, and the following Eq. [7] can be obtained using Eqs. [4] and [5].

$$\begin{matrix}[ Eq . 7 ] & \\ \frac{\dot{γ}}{2} = {g}_{y}^{′} \dot{V} + 2 {g}_{y}^{′} {g}_{x}^{′} {V}^{2} - \frac{{V}_{y}}{2} {g}_{x}^{′} + K ( \frac{γ}{2} - {g}_{y}^{′} V ) & [ 7 ]\end{matrix}$$

Taking Eq. [6] into consideration in the above Eq. [7], the steering angle δ is obtained by the following Eq. [8].

$$\begin{matrix}[ Eq . 8 ] & \\ δ = \frac{2 K}{b 1} ( {g}_{y} V - \frac{γ}{2} ) - \frac{a 11}{b 1} γ + \frac{2 {g}_{y}}{b 1} \dot{V} - \frac{{g}_{x}}{b 1} V γ + \frac{4 {g}_{x} {g}_{y}}{b 1} {V}^{2} & [ 8 ]\end{matrix}$$

Note that a11 in Eq. [8] can be represented by the following.

$$\begin{matrix}[ Eq . 9 ] & \\ {a}_{11} = - \frac{2}{{I}_{v}} ( {K}_{f} {l}_{f}^{2} + {K}_{r} {l}_{r}^{2} ) & [ 9 ]\end{matrix}$$

Note that in Eq. [9], Kf represents the cornering power of the front wheels, and if represents the distance from the center of gravity to the front wheels. Further, Kr represents the cornering power of the rear wheels, and lr represents the distance from the center of gravity to the rear wheels.

In the right side of the formula [8], as seen from left to right, the first term indicates the basic control amount which is a term for passing the passage target point P under a steady state, and the second and subsequent terms indicate the correction control amounts which are the correction terms for use under a transitional state.

Note that a steady traveling indicates a traveling state where the yaw rate and the velocity of the own vehicle are constant, and the steady state indicates a state where the vehicle is traveling steadily. The transitional state indicates a state that is not stable.

The second term is a correction term for a case when the yaw rate changes, and the third term is a correction term for a case when the acceleration in the front-rear direction changes. The fourth term is a correction term for a case when the acceleration in the lateral direction changes, and the fifth term is a correction term for a case when the velocity changes.

Next, a command based on the calculated control amounts is outputted to the vehicle control actuator 27 (S180). According to this process, the own vehicle can travel along the set trajectory.

Next, it is determined whether the vehicle control by automatic driving has finished (S190). If the vehicle control has not finished (S190: NO), the process returns to S110. On the other hand, if the vehicle control has finished (S190: YES), the vehicle control process is terminated.

### [1-3. Effects]

In the above-described vehicle control device 1, the control unit 10 acquires a passing target point representing the position of the point that the own vehicle is to pass in the future and generates a trajectory for passing the passing target point. Further, the control unit 10 calculates and outputs control amounts of the own vehicle for causing the own vehicle to travel according to the trajectory.

According to such a vehicle control device 1, since it sets the passing target point that the own vehicle is to pass in the future and controls the vehicle according to the trajectory passing through the passing target point, it is possible to suppress the frequency of steering correction made before reaching the passing target point from occurring. Thus, the riding comfort can be improved.

In the above-described vehicle control device 1, the control unit 10 calculates the control amounts of the own vehicle taking into account the motion characteristics of the vehicle.

According to such a vehicle control device 1, since the control amounts are calculated taking into account the motion characteristics, it is possible to control the vehicle preferably according to the trajectory.

In the above-described vehicle control device 1, the control unit 10 calculates, as a basic control amount, a control amount of the own vehicle under a steady state where the own vehicle performs steady traveling, and calculates, as correction control amounts, the difference with respect to the control amounts of the own vehicle under a transitional state where the own vehicle is not performing steady traveling. Then, the sum of the basic control amount and the correction control amounts is outputted as the control amount of the own vehicle.

According to such a vehicle control device 1, since the basic control amount for use under a steady state is corrected by the correction control amounts for use under a transitional state, the calculation can be simplified.

In the above-described vehicle control device 1, the control unit 10 obtains the condition for the own vehicle to travel along the trajectory and calculates the control amount that satisfies this condition.

According to such a vehicle control device 1, it is possible to more easily make the own vehicle to travel according to the obtained trajectory.

In the above-described vehicle control device 1, the control unit 10 generates an arc trajectory that passes through the current position of the own vehicle and the passing target point.

According to such a vehicle control device 1, since an arc trajectory is generated as the trajectory along which the own vehicle should travel, it is possible to control the own vehicle comfortably with a simple calculation.

### [2. Other Embodiments]

The present disclosure is not to be construed as being limited in any way by the above-described embodiment. In addition, although the reference numbers used in the description of the above embodiment are used as appropriate in the claims, they are used for the purpose of facilitating the understanding of the disclosure according to each aspect, and they do not limit the technical scope of the disclosure according to each aspect. The function of one constituent element in the above embodiment may be distributed to a plurality of constituent elements, or the functions of a plurality of constituent elements may be integrated into one constituent element. Further, a part of the configuration of the above embodiment may be omitted as long as the problems can be solved. Furthermore, at least a part of the configuration of the above embodiment may be added or substituted in the configuration of the other embodiments described above. The embodiments of the present disclosure include any mode included in the technical ideas specified by the language of the claims.

In addition to the above-described vehicle control device 1, the present disclosure may be realized in various forms such as a system comprising the vehicle control device 1, a program for causing a computer to function as the vehicle control device 1, a medium storing the program, and a method for controlling a vehicle.

### [3. Correspondence Between the Configuration of the Embodiment and the Means of the Present Disclosure]

Of the processes executed by the control unit 10 in the above embodiment, the process of S140 corresponds to a target point acquisition unit in the present disclosure, and the process of S150 in the above embodiment corresponds to a trajectory generation unit in the present disclosure. Further, the process in S170 in the above embodiment corresponds to a control amount calculation unit, a basic calculation unit, a correction calculation unit, and a control amount outputting unit in the present disclosure.

1. A vehicle control device mounted on an own vehicle and configured to control motion of the own vehicle, comprising:
a target point acquisition unit configured to acquire a passing target point representing a position of a point that the own vehicle aims to pass in the future;
a trajectory generation unit configured to generate a trajectory for the own vehicle to pass through the passing target point; and
a control amount calculation unit configured to calculate and output, based on vehicle motion characteristics representing characteristics that are dependent on physical motion of the own vehicle, a control amount of the own vehicle for causing the own vehicle to travel according to the trajectory.

2. The vehicle control device according to claim 1, wherein the control amount calculation unit comprises:
a basic calculation unit configured to calculate, as a basic control amount, a control amount of the own vehicle under a steady state where the own vehicle performs steady traveling;
a correction calculation unit configured to calculate, as a correction control amount, a difference from the control amount of the own vehicle under a transitional state where the own vehicle is not performing steady traveling; and
a control amount outputting unit configured to output, as a control amount of the own vehicle, the sum of the basic control amount and the correction control amount.

3. The vehicle control device according to claim 1, wherein
the control amount calculation unit obtains a condition for the own vehicle to travel along the trajectory and calculates a control amount that satisfies the condition.

4. The vehicle control device according to claim 1, wherein
the trajectory generation unit generates, as the trajectory, an arc trajectory that passes through a current position of the own vehicle and the passing target point.

5. (canceled)
